(19) United States
(12) Patent Application Publication
(10) Pub. No.: US 2012/0155097 A1
(43) Pub. Date: Jun. 21, 2012

(54) ILLUMINABLE BABY STROLLER

(76) Inventor: Gerald Gross, Miami, FL (US)

(21) Appl. No.: 13/208,430

(22) Filed: Aug. 12, 2011

Related U.S. Application Data
(60) Provisional application No. 61/424,744, filed on Dec. 20, 2010.

(51) Int. Cl. B60Q 9/00; B62B 7/00

(52) U.S. Cl. 362/459; 280/47.38

(57) ABSTRACT

An illuminable baby stroller having embedded light sources and means for controlling the lights, the light sources preferably comprising light emitting diodes (LEDs) embedded in the frame of the stroller in translucent sections of the frames making the stroller visible in dim lighting and in the dark wherein the stroller includes a forward light source that illuminates the path in front of the stroller and a rear light source for providing illumination behind the stroller and includes at least one red light source, the light sources being powered by a rechargeable battery that is permanently concealed in a tray to prevent access by the child and powered by an electric circuit and switch that are secured in the frame or a tray of the stroller to provide convenient access for the caretaker while keeping it out of reach from the child.

### CROSS REFERENCE TO RELATED APPLICATIONS

This application claims the benefit of provisional patent application Ser. No. 61/424,744 filed Dec. 20, 2010.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to an illuminable baby stroller, and more particularly, to a baby stroller having lighting sources strategically placed and imbedded in the stroller body for illuminating the stroller in dim light, such as at dusk, night and early in the morning.

2. Description of the Background Art

Baby strollers are well known in the background art. They come in a variety of colors, styles, such as three-wheeled and four-wheeled models, and accessories. The use of baby strollers is enjoyable for the child and its parents or caretaker. However, the use of strollers in dim lighting or in the dark, such as early in the morning, at dusk or at night, can be unsafe and dangerous. A stroller is difficult to see in these conditions placing it at risk of being hit by a vehicle or bicycle. In addition, when using a stroller in dim light or dark conditions it is difficult to see in front of the stroller to spot any upcoming dangerous conditions, such as objects, animals, ditches and bodies of water.

While there are a few strollers known that have lights attached to the stroller, they are ineffective, unsafe or too complicated for practical use. For instance, these lighted strollers use lights attached to the stroller which could interfere with the strollers use, and even safe use, as the infant could easily get pinched or bruised when touching or bumping into the light source. These lights are also prone to breakage. In addition, they use light bulbs that generate heat which would place the infant at risk of being burned when touching the light. Some of these strollers also have switches within reach of the infant exposing them to another source of potential harm. Moreover, there are disclosures of lighted strollers that do not have a forward facing light source for illuminated a path being traveled or tail lights for alerting traffic approaching from behind the stroller. The lighted strollers known are also not adapted for permanently concealing a battery while still being able to recharge it or the use of a 12 volt battery source. Furthermore, the lighted strollers known tend to use battery sources that are accessible by the child. Because of these shortcomings, the marketplace lacks a safe, reliable and acceptable baby stroller that emits light.

As noted, the lighted strollers known fail to adequately and effectively the problems identified herein. For instance, U.S. Pat. No. 6,394,633, issued to Perez, discloses an illumination system having a headlamp, side lamps, a rear lamp and an interior lamp, a battery and multiple switches connected to the exterior of a baby stroller. U.S. Pat. No. 5,938,216, issued to Weng, discloses an illumination sound system consisting of an illuminating device, a speaker, a signal transmitting device, a control circuit and magnetic switch that are mounted on the outside of the stroller. U.S. Pat. No. 5,499,835, issued to Skirchak, Jr. et al., discloses a motorcycle stroller having an exterior head lamp. U.S. Pat. No. 4,896,894, issued to Singletary, discloses a stroller carseat apparatus having a scissor-like frame, electric circuit and light source on the top of the seat that illuminates when the frame is extended and locked to indicate that the seat is ready for use as a stroller. U.S. Patent Publication Nos. 2003/0185018 and 2010/0027285, filed by Comrada, discloses a stroller light that attaches to a stroller and consists of a hollow housing that holds a battery pack, electric circuit and plurality of LEDs mounted through apertures on the front and sides of the housing. U.S. Patent Publication No. 2009/0244916, filed by Conwell et al., disclose baby stroller safety light assemblies that consists of two light assemblies that connect to the front legs of a baby stroller. U.S. Patent Publication No. 2009/0080207, filed by Hurwitz, discloses a safety lighting system integrated within a vehicle, namely a bicycle or jogging stroller. Hurwitz discloses a lighting segment in the vehicle frame that necessitates the use of apertures for holding individual LED's and a microprocessor for controlling the lights, while lacking important lighting sources. For instance, Hurwitz fails to disclose a lighting system having a forward facing light source for illuminating a path being traveled or tail lights for alerting traffic approaching from the behind the stroller. Hurwitz also discloses a system having a battery power source that appears accessible to children. Moreover, Hurwitz fails to disclose how the wiring is designed or how the battery power source is recharged. Accordingly, the above noted patents and published patent applications disclose light assemblies for strollers that represent the above noted shortcomings that the instant invention is intended to overcome.

An illuminable baby stroller having an imbedded light source, such as LED's or fiber optic lines, placed within the frame or body of the stroller with the controls out of reach from the infant would eliminate the above noted risks and be well received by parents. It is, therefore, to the effective resolution of the aforementioned problems and shortcomings of the prior art that the present invention is directed. The instant invention addresses this unfulfilled need in the prior art by providing an illuminable baby stroller with imbedded light sources, as contemplated by the instant invention disclosed herein.

### BRIEF SUMMARY OF THE INVENTION

In light of the foregoing, it is an object of the present invention to provide an illuminable baby stroller.

It is also an object of the instant invention to provide an illuminable baby stroller having embedded light sources.

It is another object of the instant invention to provide an illuminable baby stroller that is safe for the infant.

It is an additional object of the instant invention to provide an illuminable baby stroller that is cost effective for mass production.

It is a further object of the instant invention to provide an illuminable baby stroller that is reliable and convenient.

In light of these and other objects, the instant invention comprises an illuminable baby stroller having embedded light sources and means for controlling the lights. By illuminating the stroller, the parent or caretaker and infant are easier to see decreasing the chances of being hit by a vehicle or bicycle thereby enhancing their safety. The light sources preferably comprise light emitting diodes (LEDs) embedded in the frame of the stroller along with the wiring and power source that is permanently concealed yet rechargeable. Those portions of the frame are transparent or translucent to emit light from the stroller when activated, making the stroller visible in dim lighting and in the dark. When the lighting source in the stroller is activated it also illuminates the path in front of the stroller so the person pushing the stroller can see any objects or obstructions it may be approaching and provides tail lights for alerting traffic approaching from behind the stroller, once again improving safety. The light sources preferably emit white light, especially in the front of the illuminable stroller. At least one red light beam is emitted outward from each side the stroller. The light sources, however, may comprise more than one red light. The light sources are controlled by a battery powered electric circuit and switch that are preferably secured in a permanently concealed compartment on the stroller, such as in a tray, to provide convenient access for the caretaker while keeping it out of reach from the child. The wires are also concealed to further insure safety.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of the illuminable stroller in accordance with the preferred embodiment of the instant invention.

FIG. 2 is a circuit diagram of the illuminable stroller of FIG. 1 in accordance with the preferred embodiment of the instant invention.

FIG. 3 is a perspective view of the illuminable stroller with three wheels in accordance with an alternative embodiment of the instant invention.

FIG. 4 is a perspective view of the illuminable stroller with four sets of wheels in accordance with a second alternative embodiment of the instant invention.

FIG. 5 is a plan view of the illuminable stroller showing the power source, storage compartment and cup holder in accordance with the second alternative embodiment of the instant invention.

FIG. 6 is a circuit diagram for activating and deactivating the light sources in accordance with an embodiment of the instant invention.

FIG. 7 is a circuit diagram for activating and deactivating the light sources in accordance with another alternative embodiment of the instant invention.

### DETAILED DESCRIPTION OF THE INVENTION

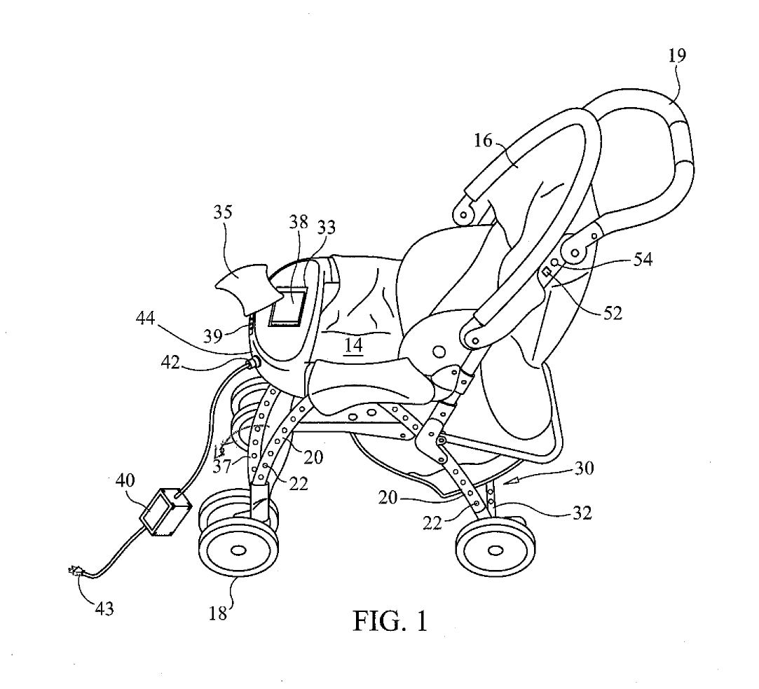

With reference to the drawings, FIGS. 1 to 7 depict the preferred and alternative embodiments of the instant invention which is generally referenced as an illuminable stroller and, or by numeric characters 10 or 100. In accordance with the preferred embodiment, the illuminable stroller 10 comprises a baby stroller 12 having embedded light sources and means for controlling the lights. The illuminable stroller 10 emits light when activated to make the stroller 12 visible in dim lighting and in the dark. By illuminating the stroller 12, the parent or caretaker and infant are easier to see decreasing the chances of being hit by a vehicle or bicycle thereby enhancing their safety. When the lighting source in the stroller 12 is activated it also illuminates the path in front of the stroller 12 so the person pushing the stroller can see any objects or obstructions it may be approaching, once again improving their safety. The light sources preferably emit white light, especially in the front of the illuminable stroller 10. At least one red light beam is emitted outward from each side the stroller 12. The light sources, however, may comprise more than one red light.

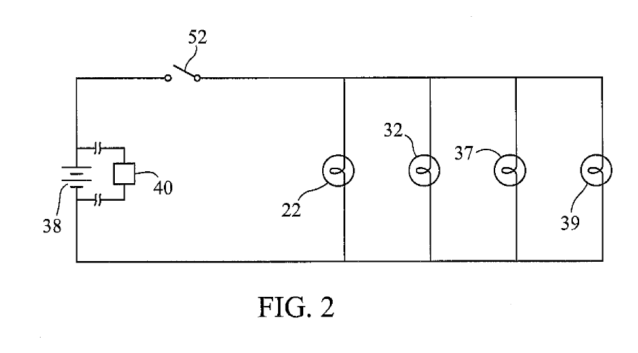

With reference to FIGS. 1 and 2, the preferred embodiment of the illuminable stroller 10 comprises a baby stroller frame 12, having a seat portion 14, a foot rest 15, a canopy 16, a plurality of wheels 18, a pushing handle 19, side frame legs 20 having one or more sections that are translucent for passing light, a light source 22 disposed in the side frame legs 20 proximal the translucent sections, a rear frame axle 30 having one or more translucent sections, a light source 32 disposed in said rear frame axle proximal the translucent sections, a front tray 33 having a battery compartment 34 for concealing a DC battery power source 38 and at least one translucent section, a light source disposed in the tray 34 proximal the tray's translucent section for lighting a path in front of the stroller with a more intense light source, translucent section in the foot rest 15 with a more instense light source disposed in the foot rest 15 proximal its translucent section to illuminate the path in front of the stroller 10, and a switch 52 in electrical communication with the light sources and battery 38. The tray 33 may include a cover 35 for providing initial access to the battery compartment 34 for placing the battery 38, which would preferably be permanently sealed once the battery 38 is installed. The instant invention 10 also comprises a charger 40 having an AC power plug 43 at one end for plugging into an AC power source and battery recharging plug 42 at the opposite end. The recharging plug 42 plugs into a recharging receptacle 44 formed in the tray 33 in a manner that electrically communicates with the battery power source 38 for recharging the battery 38 without having to remove it from the battery compartment 34. The light sources 22, 32, 37 and 39 are electrically connected to the battery 38 and switch 52 by wiring that is embedded in the frames 20 and 30, the foot rest 15 and tray 33. The switch 52 is connected in series with the battery 38 for applying or removing power from the light sources 22, 32, 37 and 39. The light sources 22, 32, 37 and 39 preferably comprise a plurality of light emitting diodes (LED's) that are secured to an electrical strip or harness, which is secured inside the side frame legs 20, rear frame leg 30, foot rest 15 or tray 33, respectively.

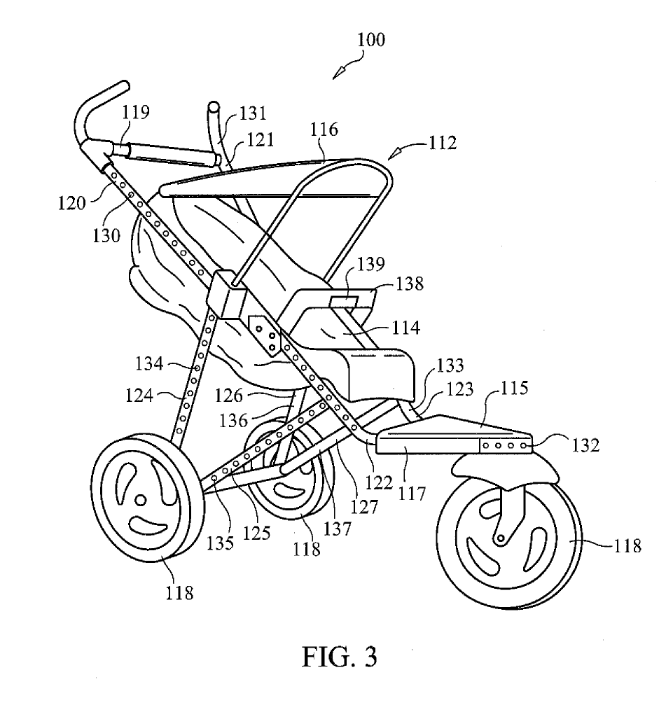

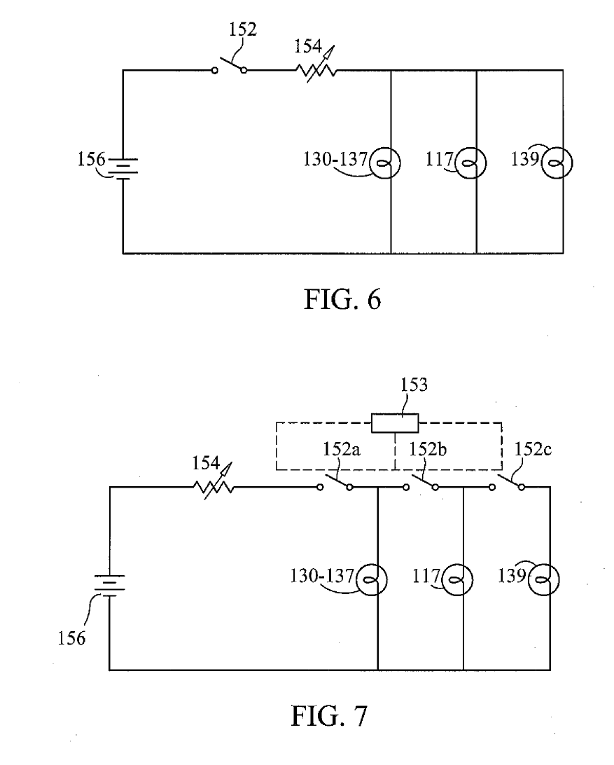

With reference to FIG. 3, in accordance with the first embodiment of the instant invention, the illuminable stroller 100 comprises a baby stroller 112 having a seat portion 114, foot rest 115, canopy 116, light source embedded in the foot rest 115, plurality of wheels 118, plurality of hollow translucent frame tubes 120-127, light sources 130-137 secured inside respective frame tubes 120-127, infant tray 138, light source 139 embedded in the infant tray 138 and upper storage assembly 140 having a cup holder 142, storage compartment 143, storage compartment door 144, storage compartment hinge 145, storage compartment latch 146, battery compartment 147, battery compartment door 148, battery compartment hinge 149, battery compartment door screw 150 and switch 152 for activating and deactivating the light sources 130-137. The seat portion 114, canopy 116 and wheels 118 are as known in the art. The light sources 117, 130-137 and 139 preferably comprise LED's but may also comprise fiber optic lighting, and are completely enclosed in select translucent or transparent portions of the stroller 112, as described further herein, so as to be concealed from touching while being able to emit light. The light sources 117, 130-137 and 139 are powered by a DC power source comprising batteries 56 that are securely disposed in the battery compartment 147, as shown in FIG. 2. Power from the batteries 156 is supplied to and removed from the light sources 117-130-137 and 139 by actuating the switch 152. The instant invention 100 may also include a dimmer 154 for controlling the level of light emitted. The alternative embodiments of the electrical circuits are shown in FIGS. 6 and 7, respectively.

Still referring to FIG. 3, the frame tubes 120-127, foot rest 115 and infant tray 138 are retrofitted with the light sources 130-137, 117 and 139, respectively. The foot rest 115 is retrofitted with the light source 132 embedded in the sides 117 of the foot rest 115. A channel is formed along a portion of or around the complete perimeter of the foot rest 115 for receiving the light source 117. The foot rest light source 132 is encased in translucent or transparent tubing that is secured in the channel with an adhesive, hardware or other securing devices known in the art. The frame tubes 120-127 are translucent or transparent throughout their complete lengths or partial lengths or in select portions. The frame tubes comprise upper right and left tubes 120-121, lower right and left tubes 122-123, upper and lower right wheel tube extensions 124-125 and upper and lower left wheel tube extensions 126-127. The upper right and left tubes 120-121 securely contains and enclose light sources 130 and 131, respectively, inside their hollow interiors. The lower right and left tubes 122-123 securely contain and enclose light sources 132-133, respectively, inside their hollow interiors. The light source 139 is securely disposed within the body of the infant tray 138 behind a translucent or transparent section at the front of the tray 138 to allow the emission of light when activated. It is important to note that the illuminable stroller 100 may comprise light sources in just the upper right and left tubes 120-121, lower right and left frame 122-123, upper right and left tube wheel extensions 124-126 or lower right and left frame tube wheel extensions 125-127, or any combination thereof. The foot rest light source 132 and infant tray light source 139 are preferably used with all combinations of light sources 130-137 in selected frame tubes 120-127.

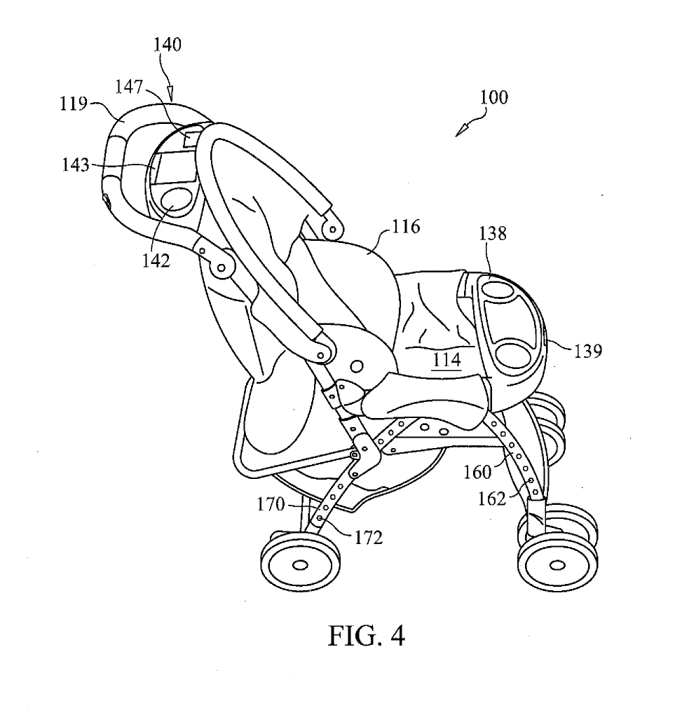

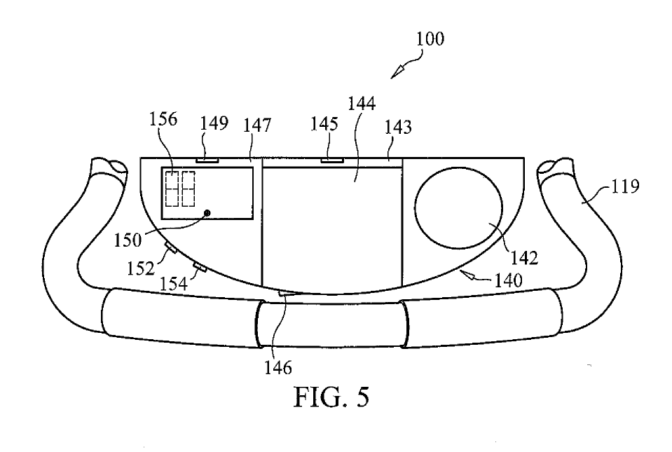

With reference to FIGS. 4-5, the second embodiment of the instant invention 100 comprises the illuminable stroller 100 with four sets of wheels 118. The second embodiment of the illuminable stroller 100 comprises right and left front frame tubes 160-170, right and left rear frame tubes, right and left light sources 162-172, foot rest 115, infant tray 138, seating area 114, upper storage assembly 140 and canopy. The upper storage assembly 140 has a cup holder 142, storage compartment 143, storage compartment door 144, storage compartment hinge 145, storage compartment latch 146, battery compartment 147, battery compartment door 148, battery compartment hinge 149, battery compartment door screw 150 and switch 152 for activating and deactivating the light sources 130-137, as shown in FIG. 4. The second embodiment of the illuminable stroller 100 comprises light sources 162-172 securely disposed and secured in the front right and left frame tubes 160-170, light source 139 in the infant tray 138 at the front side and light source 117 in the foot rest 115 at the front. The front right and left frame tubes are transparent or translucent throughout their lengths or in one or more sections for allowing the emission of light. The foot rest and infant tray have transparent or translucent sections in their front surfaces for emitting light.

With reference to FIG. 6, a first circuit diagram is shown to indicate one type of electrical circuit that may be employed in the illuminable stroller 10 or 100 to provide power to the light sources and control the activation and deactivation of the light sources. The first circuit may be employed in the preferred embodiment 10 or first and second alternative embodiments 100 of the instant invention. Referring to FIG. 5, the first circuit comprises a DC battery power source 156, switch 152 and dimmer 154 connected in series and the light sources 130-137, 117 and 139 connected in parallel. In this arrangement, when the switch 152 is closed all the light sources are energized. Likewise, when the switch 152 is opened the light sources 130-137, 117 and 139 are de-energized. The dimmer 154 comprises a rheostat or variable resistor which dictates the amount of current flowing to the light sources. The level of brightness of the light sources 30-137, 117 and 139 is controlled by manipulating the dimmer 154. If any of the light sources should cease to work the other light sources would continue to work.

With reference to FIG. 7, a second circuit diagram is shown to indicate a second type of electrical circuit that may be employed in the preferred illuminable stroller 10 or alternative illuminable strollers 100 to provide power to the light sources and control the activation and deactivation of the light sources. Referring to FIG. 7, the second circuit comprises a DC battery power source 156, switches 152a-c, dimmer 154 and controller for selecting one or more of switches 152a-c. The second circuit also comprises light sources 130-137, 117 and 139. In this arrangement, the controller 153 operates as a variable switch wherein manipulating it determines whether switches 152a, 152b and 152c are all opened or closed or any combination thereof. For instance, when turning the controller 153 in one direction the light sources may turn on in sequential order and when turning the controller 153 in the opposite direction they would turn off in reverse sequential order. When switch 152a is opened and closed light sources 130-137 are de-energized and energized, respectively. When switch 152b is opened and closed light source 117 is de-energized and energized, respectively. When switch 152c is opened and closed light source 39 is de-energized and energized, respectively.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. An illuminable baby stroller, said stroller comprising:
a stroller having a seat and plurality of frame tubes;
at least one of said frame tubes having at least one translucent section;
at least one light source disposed in said translucent section;
a forward light source for projecting light in front of the stroller for illuminating the path in front of the stroller; and
power means, in electrical communication with said light source and said forward light source, for selectively providing power to said light sources.

2. A stroller as recited in claim 1, further comprising:
a lower cross brace in the front portion of said stroller; and
a light source, in electrical communication with said power means, embedded in said cross brace.

3. A stroller as recited in claim 1, further comprising:
a tray proximal said seat; and
a light source, in electrical communication with said power means, embedded in a front section of said tray.

4. A stroller as recited in claim 3, further comprising:
at least one compartment defined by said accessory tray for storing said power means, said compartment being permanently sealed from access.

5. A stroller as recited in claim 4, wherein said power means comprises:
a rechargeable DC battery power source in electrical communication with said light source, said DC battery source comprising 12 volts; and
at least one switch in electrical communication with said light source and said power source.

6. A stroller as recited in claim 1, wherein said power means comprises:
a rechargeable DC battery power source in electrical communication with said light source and comprising 12 volts; and
at least one switch in electrical communication with said light source and said power source.

7. A stroller as recited in claim 1, further comprising:
a plurality of frame tubes, said frame tubes each having a translucent section and at least one light source in said translucent section in electrical communication with said power source.

8. A stroller as recited in claim 1, wherein said light source comprises:
at least one light source that projects white light.

9. A stroller as recited in claim 8, wherein said light source comprises:
at least one light source that projects red light.

10. A stroller as recited in claim 1, wherein said light source comprises:
at least one light source in a rear section of said stroller.

11. A stroller as recited in claim 1, wherein said light source comprises:
at least one light source on at least one side of said stroller.

12. A stroller as recited in claim 1, wherein said light source comprises:
a strip of light emitting diodes in electrical communication with said power source.

13. A stroller as recited in claim 1, wherein said light source comprises:
fiber optic lines.

14. An illuminable baby stroller, said stroller comprising:
a stroller having a seat and plurality of frame tubes;
at least one of said frame tubes having at least one translucent section;
at least one light source disposed in said translucent section;
a rear light source for projecting light behind the stroller; and
power means, in electrical communication with said light source and said forward light source, for selectively providing power to said light sources.

15. A stroller as recited in claim 14, further comprising:
a lower cross brace in the front portion of said stroller; and
a light source, in electrical communication with said power means, embedded in said cross brace.

16. A stroller as recited in claim 14, further comprising:
a tray proximal said seat; and
a light source, in electrical communication with said power means, embedded in a front section of said tray.

17. A stroller as recited in claim 16, further comprising:
at least one compartment defined by said accessory tray for storing said power means, said compartment being permanently sealed from access.

18. A stroller as recited in claim 17, wherein said power means comprises:
a rechargeable DC battery power source in electrical communication with said light source; and
at least one switch in electrical communication with said light source and said power source.

19. A stroller as recited in claim 1, wherein said power means comprises:
a rechargeable DC battery power source in electrical communication with said light source; and
at least one switch in electrical communication with said light source and said power source.

20. A stroller as recited in claim 14, further comprising:
a light source disposed in the front of said stroller for projecting light in front of the stroller.
